(19) United States
(12) Patent Application Publication
(10) Pub. No.: US 2008/0157585 A1
(43) Pub. Date: Jul. 3, 2008

(54) HUB FOR A BICYCLE WHEEL HAVING A DISC BRAKE

(75) Inventor: Mario Meggiolan, Creazzo (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.R.L., Vicenza (IT)

(21) Appl. No.: 11/956,213

(22) Filed: Dec. 13, 2007

(30) Foreign Application Priority Data
Dec. 13, 2006 (IT) MI2006A002385

(51) Int. Cl. B60B 27/02

(52) U.S. Cl. 301/110.5

(57) ABSTRACT

The present invention provides a bicycle hub that is usable with a disc brake. The hub has a tubular body extending along a longitudinal axis between the ends thereof. One end of the hub is configured to mate with and retain a brake disc on a disc seat that has a predetermined configuration. Spaced from the disc seat along the longitudinal axis there is a fastener portion of the hub which is configured to receive a fastener that locks the disc on the hub. The disc seat and fastener portion are separated by section of the tubular body that does not form any part of either the disc seat or the fastener portion

### CROSS-REFERENCE TO RELATED APPLICATION

This application claims the benefit under 35 U.S.C.§119 to Italian Patent Application No. MI2006A002385.

### BACKGROUND

The present invention regards a hub usable in a bicycle wheel having a disc brake.

In bicycle wheels with disc brakes, the brake disc is normally mounted so as to make the disc integral in rotation with the wheel. Known solutions to using disc brakes are flawed in that they either have limited mechanical resistance or they require a relatively thick hub that adds undesired weight or compelxity to the hub.

The problem underlying the present solutions result in the art desiring a hub suitable for a disc brake hub that can be easily mounted without requiring technical solutions which weigh down the hub or complicate its manufacture.

### SUMMARY OF THE INVENTION

The present invention comprises a tubular body extended axially along a rotation axis of the wheel that includes a coupling profile for reception and locking in position a brake disc. The hub is further characterised by having the disc coupling profile and the locking portion physically separated from each other along the axis of the tubular body. Using this configuration means that the disc position and locking portion are independent from each other and can be chosen and sized in an optimal manner without mutual constraints.

### BRIEF DESCRIPTION OF THE DRAWINGS

Further characteristics and advantages of the invention will be evident from the following description of several embodiments thereof, made with reference to the attached drawings. In such drawings:

FIG. 1 is a view along the longitudinal axis of a hub according to a first embodiment of the invention, with a partial section;

FIG. 2 is a perspective view of the tubular body of a hub acording to a first embodiment of the invention;

FIG. 3 is a side elevation of FIG. 2 in the direction III;

FIG. 4 is an enlarged view of the circled detail of FIG. 3;

FIG. 5 is a view along the longitudinal axis of a hub according to a second embodiment of the invention, with a partial section;

FIG. 6 is a perspective view of the tubular body of a hub according to a second embodiment of the invention;

FIG. 7 is a view along the longitudinal axis of a hub similar to the hub group of FIG. 5, assembled with a brake disc and a locking ring, and with a partial section;

FIG. 8 is an exploded view of the assembly of FIG. 7;

FIG. 9 is a side elevation of a bicycle which incorporates hub asemblies according to the invention;

FIG. 10 is an enlarged scale view of a portion of the hub group of FIG. 1.

FIG. 11 an alternative form of the end the tubular body of present invention that is devoid of threads.

### DESCRIPTION OF THE PREFERRED EMBODIMENTS

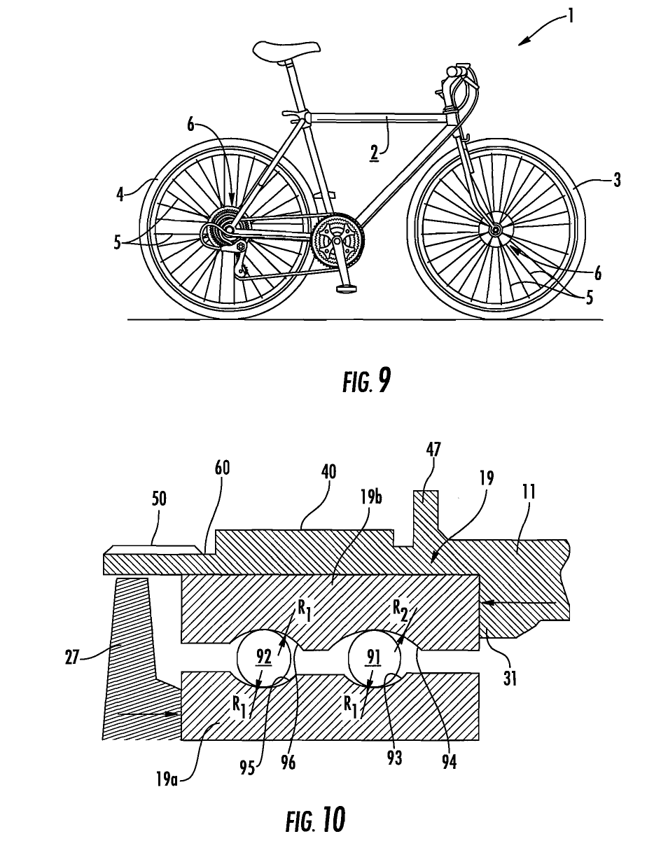

As shown in FIG. 9, a bicycle 1 typically comprises a frame 2, a front wheel 3 and a rear wheel 4, each of which has spokes 5, and, in this instance, each wheel is equipped with a disc brake assembly 6.

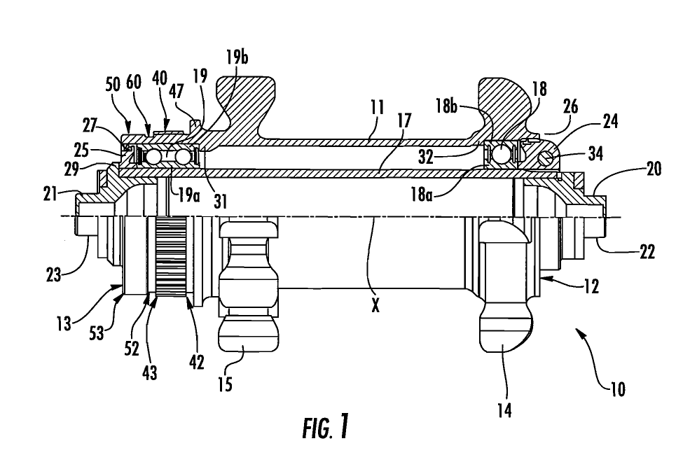

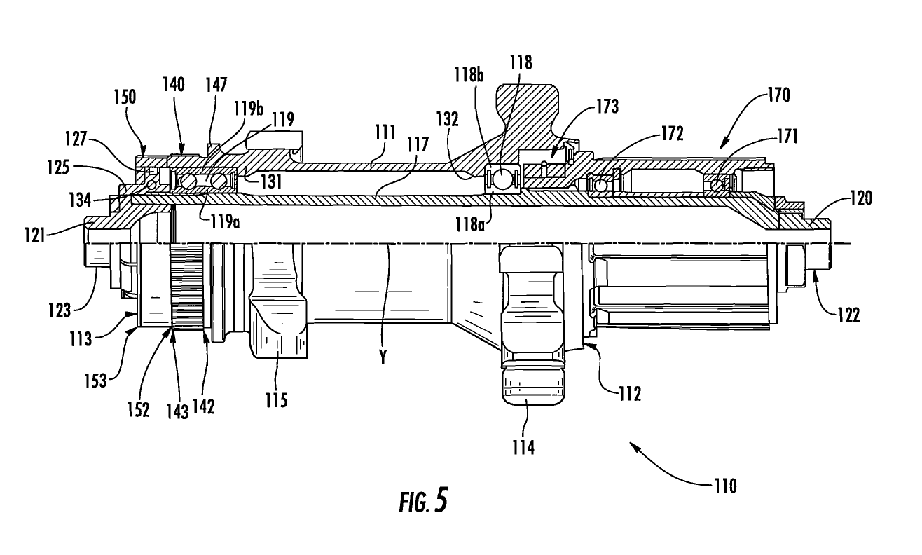

With reference in particular to FIGS. 1-4, a hub 10 according to the invention for use with the front wheel 3 of the bicycle 1 comprises a tubular body 11, extended around a longitudinal axis X extending between the ends 12 and 13 corresponding with the rotational axis of the wheel 3

The tubular body 11 is externally provided with two series of protuberances 14 and 15, not illustrated in detail since they are not concerned with the embodiments of the present invention, for the coupling to the spokes 5. Inside the tubular body 11, a spindle 17 is supported by first and second rolling bearings, respectively 18 and 19. The spindle 17 is of a known construction with right and left terminal portions 20 and 21, firmly fixed to close the opposite ends of the spindle 17 and shaped so as to provide connection seats 22 and 23 to the frame 2 of the bicycle 1. The bearing 18 is of a known one ball row type, while the bearing 19 is of a two ball row type with balls of lesser diameter than those of the bearing 18

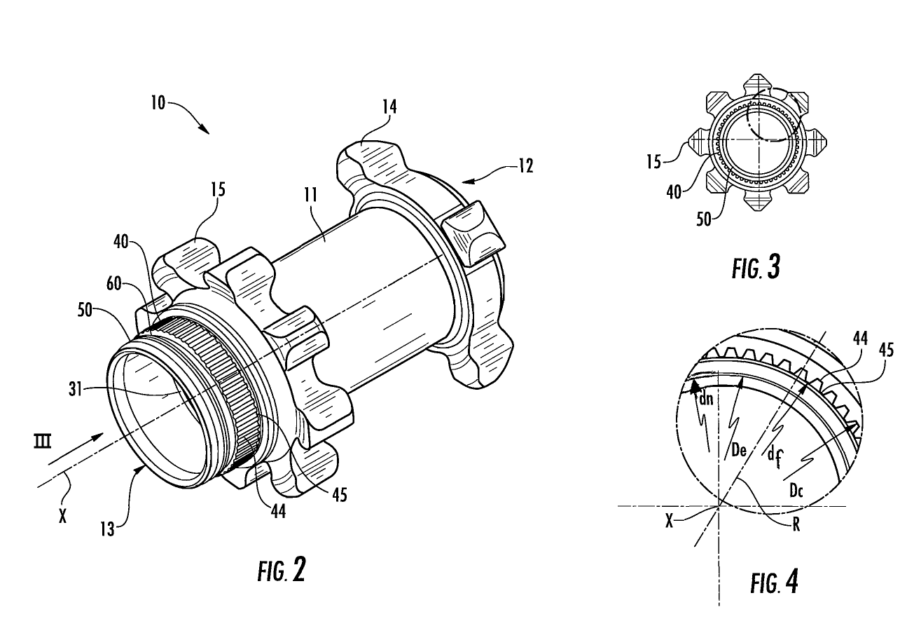

Two annular closing caps 24 and 25 are provided between the spindle 17 and the tubular body 11, equipped with respective seals 26 and 27 towards the tubular body 11. The first annular cap 24 (on the right in FIGS. 1 and 2) is screwed on the spindle 17 while the second annular cap 25 is mounted or pressed on with force applied on the spindle 17 itself.

It is noted that the mounting of the spindle 17 in the tubular body 11 provides that the left annular cap 25 goes in abutment—towards the left, with reference to FIG. 1—against a projecting flange 29 of the left terminal portion 21 (in turn made integral with the spindle 17, such as by gluing) and abutment—from the right—the inner race 19a of the second bearing 19. The outer race 19b of the same left bearing 19 abutments against a shoulder 31 formed in the tubular body 11; the shoulder 31 therefore defines a housing seat of the left bearing 19 in the tubular body 11. The right bearing 18 race 18b is in abutment against a shoulder 32 formed in the tubular body 11 and its inner race 18a is in abutment against the right annular cap 24. It will be understood that the right annular cap 24, which is screwed on the spindle 17, serves to register the bearing coupling between the spindle 17 and the annular body 11. The annular cap 24 is open ring shaped, and is tightened closed in the mounting on the spindle 17 by means of a transverse grub screw (only indicated schematically with 34), to prevent the loosening of the annular cap 24.

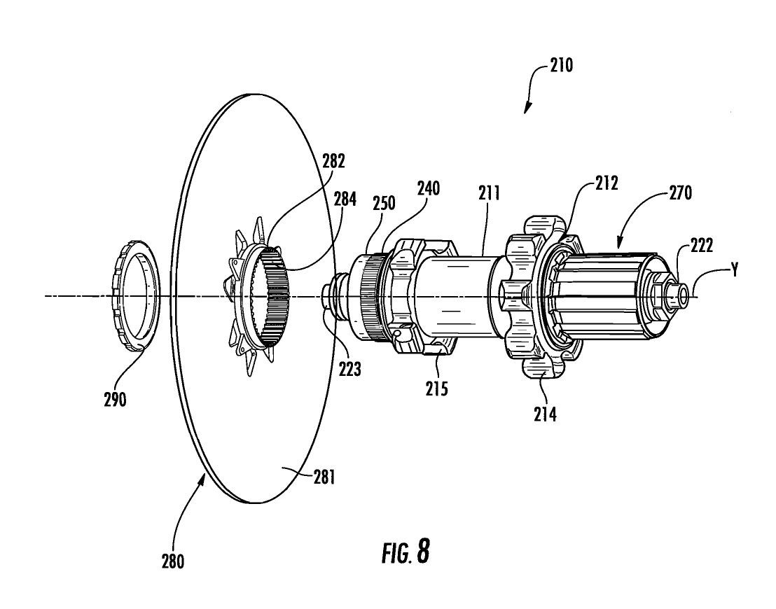

The tubular body 11 has a disc seat 40 for receiving and locking a brake disc (see element 280 in FIG. 7). The disc seat 40 comprises an outer portion of the tubular body 11 shaped according to a predetermined coupling profile. With this term it is intended that the profile of the disc seat 40 has geometric characteristics such as to permit the transmission of a torsional movement between the tubular body 11 and the brake disc mounted on the seat with a matching profile. The predetermined profile can be for example a polygonal profile, or an altered circular profile (for example, levelled along a chord) or another profile. In the preferred embodiments, the coupling profile is a splined profile, with ribs 44 and grooves 45 oriented in a direction parallel to the X axis, see FIG. 2. The ribs 44 define a maximum diameter D_{c} of the splined profile, while the grooves 45 define a minimum diameter d_{f} of the splined profile. The shoulder 47 on body 11 provides an axial abutment position for a brake disc (280) mounted on the disc seat 40.

On the side of body 11 opposite the shoulder 47, a thread 50 is formed for the coupling with a nut which holds the brake disc ( element 280 in FIG. 7) on the disc seat 40, preferably against the outer shoulder 47. As can be seen from FIG. 4, the thread 50 extends over the outside of the tubular body 11 between a right end 52 and a left end 53 and has an outer diameter Dₑ and a core diameter dₙ.

The disc seat 40 and the thread 50 are sized and separately positioned on the tubular body 11 so as to be axially separated by a intermediate portion of tubular body 11 or circumferential groove 60 that is part of neither of them. Thus, there exist a position along the longitudinal X axis in which only the disc seat 40 is present and positions in which only the thread 50 is present; there are no positions in which both the disc seat 40 and the thread 50 are present together or overlapping.

The following conditions are present in the preferred embodiments:
the thread 50 is closer than the disc seat 40 to the second end 13 of the tubular body 11, i.e. the left end 53 of the thread 50 is closer than the left end 43 of the disc seat 40 to the left end 13 of the tubular body 11;
the crest diameter D_{c} is greater than the outer diameter Dₑ;
the bottom diameter d_{f} is greater than the core diameter dₙ;
the bottom diameter d_{f} is greater than the outer diameter Dₑ;
the second end 43 of the disc seat 40 is located between the first end 52 of the thread 50 and the first end 12 of the tubular body 11;
the radial extension of the ribs 44 and grooves 45 between the bottom diameter d_{f} and the outer diameter Dₑ is comprised between 0.5 and 2 mm, and preferably between 0.5 and 1 mm.

With respect to the predetermined coupling profile, it is preferred that the ribs 44 and grooves 45 have a trapezoidal shape which is symmetric with respect to a radial plane R (see FIG. 4). The number of the ribs 44 is preferably between 10 and 60, more preferably between 20 and 60, and most preferably between 40 and 60. The number of the grooves 45 is of the same range as that selected for the ribs 44.

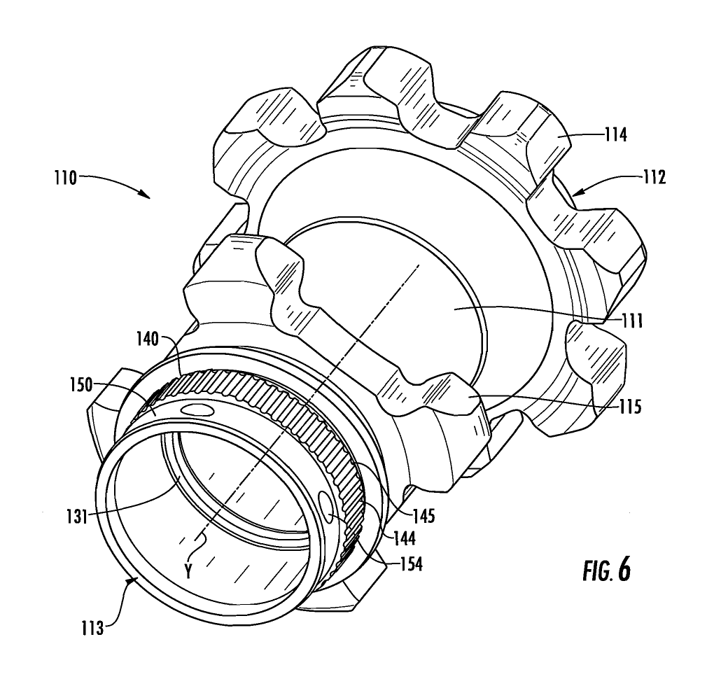

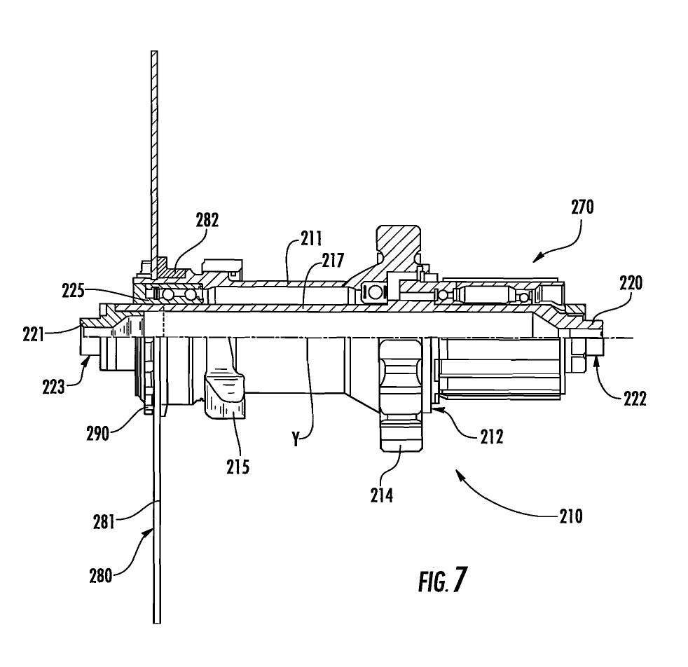

With reference in particular to FIGS. 5 and 6, a hub 110 for the rear wheel 4 of the bicycle 1 comprises a tubular body 111, extended around a longitudinal axis Y which is parallel to the longitudinal axis X. Except as described below, the hub 110 is as described with respect to hub 10 similar elements have similar numbers plus 100.

Unlike the hub 10, the hub 110 comprises a pinion-carrier group 170, rotatably mounted on the spindle 117 by means of rolling bearings 171 and 172, and coupled to the tubular body 111 by means of a freewheel connection 173, close to the first end 112 thereof. The pinion-carrier group 170 is of know construction and will not be described in detail below.

An annular closure cap 125 is then provided between the spindle 117 and the tubular body 111, equipped with a seal 127 towards the tubular body 111. The annular cap 125 is screwed on the spindle 117.

It is noted that the mounting of the spindle 117 in the tubular body 111 provides that the inner race 118a of the right bearing 118 goes in abutment—towards the right, with reference to FIG. 5—against a shoulder 129 formed on the spindle 117, while the outer race 118b of the same right bearing 118 receives a shoulder 132 in abutment, formed in the tubular body 111; the shoulder 132 therefore defines a housing seat of the right bearing 118 in the tubular body 111. The left bearing instead has its outer race 119b in abutment—towards the right—against a shoulder 131 formed in the tubular body 111 and its inner race 119a in abutment—towards the left—against the annular cap 125; the shoulder 131 therefore defines a housing seat of the left bearing 119 in tubular body 111. In this manner, it is understood that the annular cap 125, which—as said—is screwed on the pin 117, serves as register element of the bearing coupling between the spindle 117 and the annular body 111. The annular cap 125 is open ring shaped and in the mounting is tightened closed on the spindle 117 by means of a transverse grub screw (indicated only schematically with 134), in order to prevent the loosening of the annular cap 125.

A disc seat 140 is provided outside the tubular body 111 for reception and locking in rotation of a brake disc (not shown in FIGS. 5 and 6). The disc seat 140 comprises an outer portion of the tubular body 111 comprised between a first right end 142 and a second left end 143, shaped according to a form coupling profile, equal to that of the disc seat 40 of the hub 10. In particular, the form coupling profile of the disc seat 140 of the hub group 110 is a splined profile, with ribs 144 and grooves 145, oriented in a direction parallel to the Y axis. The ribs 144 define a maximum crest diameter D_{c} of the splined profile, while the grooves 145 define a minimum bottom diameter of the splined profile.

Close to the disc seat 140, in proximity to its right end 141, the tubular body 111 comprises an outer shoulder 147 which provides an axial abutment position for a brake disc mounted on the disc seat 140.

Still close to the disc seat 140, near its left end 143, a thread 150 is provided formed on an outer portion of the tubular body 111, for the coupling with a threaded ring nut (not shown in FIGS. 5 and 6) which holds a brake disc (it too not shown in FIGS. 5 and 6) on the disc seat 140 against the outer shoulder 147. The thread 150, equivalent to the thread 50 of the hub 10, extends along the outside of the tubular body 111 between a right end 152 and a left end 153 and has an outer diameter Dₑ and a core diameter dₙ.

The disc seat 140 and the thread 150 are sized and positioned on the tubular body 111 so as to be axially separate, in the sense specified above. More in particular, the following relations are valid in the hub 110:
the thread 150 is closer than the disc seat 140 to the second end 113 of the tubular body 111, i.e. the left end 153 of the thread 150 is closer than the left end 143 of the disc seat 140 to the left end 113 of the tubular body 111;
the crest diameter D_{c} is greater than the outer diameter Dₑ;
the bottom diameter d_{f} is greater than the core diameter dₙ;
the bottom diameter d_{f} is greater than the outer diameter Dₑ;
the second end 143 of the disc seat 140 is located at the first end 152 of the thread 150, i.e. the disc seat 140 and the thread 150 are adjacent along the Y axis.

One or more holes 154 are made in the thread 150 for the access to the locking grub screw 134 of the annular cap 125.

With reference in particular to FIGS. 7 and 8, a hub 210 is shown for the rear wheel 4 of the bicycle 1, substantially equal to the hub 110, except for insignificant details of elements extraneous to the present invention, such as the pinion carrier group 270 and the annular cap 225. Therefore, this hub 210 will not be described in detail; its elements, equivalent to the hub 110, are marked by the same reference numbers plus 100.

The hub 210 also comprises a brake disc 280 and a threaded ring nut 290. The brake disc 280 comprises a peripheral disc portion 281 which is firmly fixed to a central mounting ring 282; a central hole 284 is made in the mounting ring 282, provided with a splined profile matching the splined profile of the disc seat 240. The brake disc 280 is mounted with the mounting ring 282 on the disc seat 240, locked in rotation by the coupling between the splined profiles of the disc seat 240 and the central hole 284. The ring nut 290 pushes the brake disc 280 against the outer shoulder 247, thus ensuring that the brake disc 280 remains in engagement on the disc seat 240.

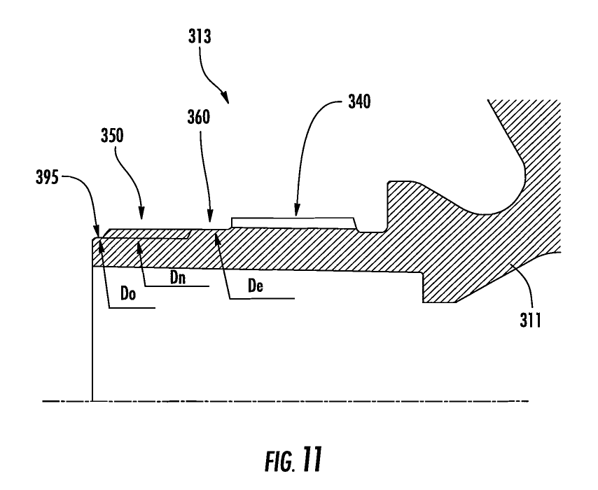

In FIG. 10, the second bearing 19 of the hub 10 is illustrated in greater detail; the bearings 119 and 219 of the hubs 110 and 210 are equivalent to the bearing 19, and thus that illustrated in FIG. 10 and described below also holds for the bearings 119 and 219.

As already stated, the bearing 19 has two ball rows, a first row 91 closer to the first end 12 of the tubular body 11 and a second row 92 closer to the second end 13 of the tubular body 11. The first ball row 91 runs along a first inner runway 93 made on the inner race 19a and on a first outer runway 94 made on the outer race 19b; the second ball row 92 runs along a second inner runway 95 made on the inner race 19a and a second outer runway 96 made on the outer race 19b.

The runways 93-96 have rounded, particularly semicircular section; the first outer runway 94 is wider than the other runways 93, 95 and 96, in particular it has a radius section R₂ greater than the radius R₁ of the other runways.

In this manner, the first ball row 91 substantially supports only radial loads and not also axial loads, which are left to the second ball row 92. This ensures a greater slidability of the bearing 19. The fact that the radial load is left to the second row 91, closer to the second end 13 of the tubular body 11, ensures a greater stiffness to the set. The choice, then, of having the runway 94 wider on the outer race 19b rather than on the inner race 19a is due to the consideration that a wider runway reduces the contact area of the balls of the runway, thus increasing the specific pressure; this phenomenon—potentially a source of problems—is more easily acceptable on the outer race 19b, which has a greater circumferential extension than the inner race 19a and therefore lower specific pressures.

FIG. 11 shows an alternative embodiment 311 of the tubular body that differs from the tubular body of FIGS. 1-4 because its axially outermost portion 395 of the second end 313 is not threaded. In this way the beginning of the thread 350 is preserved from being damaged by lateral shocks. In the illustrated embodiment the axially outermost portion 395 has an outer diameter Do that is lower or equal to the core diameter dₙ of the thread 350. Between the thread 350 and the disc seat 340 is interposed a smooth portion 360 which can have the same outer diameter Dₑ e of the thread 350, as in FIG. 11, or can be a groove.

It is known that, in a hub according to the invention, such as the hubs 10, 110 and 210, the disc seat 40, 140, 240 does not interfere with the thread 50, 150, 250, improving the mechanical stress conditions in the material of the tubular body 11, 111, 211, which can therefore be designed with a relatively very small thickness.

Moreover, due to the axially separate position of the thread 50, 150, 250 with respect to the disc seat 40, 140, 240, the radial size is much reduced, such that—by possibly employing a reduced left bearing 19, 119, 219, for example with double ball row—it is possible to keep the diameter of the brake disc 40, 140, 240 very small, and thus keep that of the tubular body 11, 111, 211 very small, equivalent to that of a tubular body of a hub for a wheel that does not have a disc brake.

Finally, the presence of the second bearing 19, 119, 219 inside the tubular body 11, 111, 211 at the disc seat 40, 140, 240 contributes to considerably stiffening the tubular body itself, precisely where the braking torque is applied, permitting risk-free mounting even of brake discs 280 with large diameters and great breaking power, such as those typical of so-called downhill bicycles, without requiring an excessive diameter of the tubular body 11, 111, 211.

What is claimed is:

1. Hub adapted to be employed in a wheel (3, 4) of a bicycle (1) of the type having a disc brake (6), comprising a tubular body (11, 111, 211, 311) extended axially along a rotation axis (X, Y) of the wheel (3, 4) between a first (12, 112, 212) and a second end (13, 113, 213), the tubular body (11, 111, 211) being provided in proximity to the second end (13, 113, 213, 313) thereof with a disc seat (40, 140, 240, 340), having a form coupling profile for reception and locking in rotation of a brake disc (280), and with a thread (50, 150, 250, 350), adapted to receive, via screwing, a ring nut (290) which holds the brake disc (280) on said disc seat (40, 140, 240), characterised in that said thread (50, 150, 250, 350) is formed on a portion of the tubular body (11, 111, 211) which is axially separate from the disc seat (40, 140, 240) and closer than the latter to the second end (13, 113, 213) of the tubular body (11, 111, 211).

2. Hub according to claim 1, wherein said thread (50, 150, 250) is formed on an outer portion of the tubular body (11, 111, 211).

3. Hub according to claim 2, wherein the disc seat (40, 140, 240, 350) comprises ribs (44, 144, 244) and grooves (45, 145, 245) having radial extensions comprised between a minimum bottom diameter (d_{f}) and a maximum crest diameter (D_{c}), wherein the thread (50, 150, 250) has a minimum core diameter (dₙ) and a maximum outer diameter (Dₑ), where the crest diameter (D_{c}) of the disc seat (40, 140, 240) is greater than the outer diameter (Dₑ) of the thread (50, 150, 250, 350).

4. Hub according to claim 3, wherein the bottom diameter (d_{f}) of the disc seat (40, 140, 240, 340) is greater than the core diameter (dₙ) of the thread (50, 150, 250, 350).

5. Hub according to claim 4, wherein the bottom diameter (d_{f}) of the disc seat (40, 140, 240, 340) is greater than or equal to the outer diameter (Dₑ) of the thread (50, 150, 250, 350).

6. Hub according to claim 1, wherein the disc seat (40, 140, 240, 340) is radially extended between a first (42, 142, 242) and a second (43, 143, 243) end oriented respectively towards the first (12, 112, 212) and second (13, 113, 213, 313) end of the tubular body (11, 111, 211), wherein the thread (50, 150, 250, 350) is axially extended between a first (52, 152, 252) and a second end (53, 153, 253) oriented respectively towards the first (12, 112, 212) and second (13, 113, 213, 313) end of the tubular body (11, 111, 211), wherein the second end (43) of the disc seat (40) is located between the first end (52) of the thread (50) and the first end (12) of the tubular body (11) with respect to the rotation axis (X).

7. Hub according to claim 2, comprising a circumferential groove (60) between the disc seat (40) and the thread (50).

8. Hub according to claim 2, comprising a not threaded portion (360) between the disc seat (340) and the threaded portion (350) having the same outer diameter (Dₑ) of the threaded portion (350).

9. Hub according to claim 1, wherein the second end (143, 243) of the disc seat (140, 240) coincides with the first end (152, 252) of the thread (150, 250).

10. Hub according to claim 1, wherein the form coupling profile is a splined profile.

11. Hub according to claim 1, wherein the tubular body (11, 111, 211) comprises an outer shoulder (47, 147, 247), in a position close to the disc seat (40, 140, 240, 340), on the opposite side with respect to the thread (50, 150, 250, 350).

12. Hub according to claim 1, wherein the disc seat has a variable diameter cross section, increasing with distance from the thread.

13. Hub according to any one of claim 2 comprising, inside the tubular body (11, 111, 211), a housing seat (32, 132, 232) of a rolling bearing (18, 118, 218), at least partially extended at the disc seat (40, 140, 240) and/or thread (50, 150, 250).

14. Hub according to claim 1, further comprising a brake disc (280), comprising a central hole (284) provided with a form coupling profile which is complementary to the form coupling profile of the disc seat (240), mounted on the disc seat (240) integral in rotation with the tubular body (211), and a threaded holding ring nut (290), screwed on the thread (250) and axially pressing against the brake disc (280), towards the first end (212) of the tubular body (211).

15. Hub according to claim 14, wherein the brake disc (280) comprises a peripheral disc portion (281) firmly fixed to a central mounting ring (282), in which mounting ring (282) the central hole (284) is made.

16. Hub according to claim 15, further comprising a spindle (17, 117, 217), rotatably supported inside the tubular body (11, 111, 211) by means of a first (18, 118, 218) and a second (19, 119, 219) rolling bearing, respectively placed in proximity to the first (12, 112, 212) and second (13, 113, 213) ends of the tubular body (11, 111, 211).

17. Hub according to claim 15, wherein the second rolling bearing (19, 119, 219) has a greater axial and a lesser radial extension than the first rolling bearing (18, 118, 218).

18. Hub according to claim 16, wherein the second bearing (19, 119, 219) is a double row ball bearing.

19. Hub according to claim 17, wherein each of the two ball rows (91, 92) of the second bearing (19, 119, 219) run along an inner runway (93, 95) and on an outer runway (94, 96), made in respective inner (19a, 119a, 219a) and outer (19b, 119b, 219b) races of the second bearing (19, 119, 219), wherein one (94) of the inner or outer runways on which one (91) of the two ball rows runs has greater width than the other runways (93, 95, 96) of the second bearing (19, 119, 219).

20. Hub according to claim 18, wherein the runway (94) having greater width is one of the runways (93, 94) on which the ball row (91) runs which is oriented towards the first end (12, 112, 212) of the tubular body (11, 111, 211).

21. Hub according to claim 18, wherein the runway (94) having greater width is one of the two outer runways (94, 96).

22. Hub according to claim 18, wherein the runway having greater width is the outer runway (94) of the ball row (91) oriented towards the first end (12, 112, 212) of the tubular body (11, 111, 211).

23. Hub according to claim 1, wherein the disc seat (40, 140, 240) comprises ribs (44, 144, 244) and grooves (45, 145, 245) having radial extension comprised between 0.5 and 2 mm.

24. Hub according to claim 1, wherein the disc seat (40, 140, 240) comprises a number of ribs (44, 144, 244) and a corresponding number of grooves (45, 145, 245) comprised between 10 and 60.

25. Hub according to claim 24, wherein the number is comprised between 20 and 60.

26. Hub according to claim 24, wherein the number is comprised between 40 and 60.

27. Hub according to claim 1 wherein the disc seat (40, 140, 240) comprises ribs (44, 144, 244) and grooves (45, 145, 245) having a symmetric trapezoidal shape.

28. Hub according to claim 1, wherein the axially outermost portion of the second end (13, 113, 213) of the tubular body (11, 111, 211)is not threaded.

29. Bicycle wheel including a hub (10, 110, 210 comprising a tubular body (11, 111, 211, 311) extended axially along a rotation axis (X, Y) of the wheel (3, 4) between a first (12, 112, 212) and a second end (13, 113, 213), the tubular body (11, 111, 211) being provided in proximity to the second end (13, 113, 213, 313) thereof with a disc seat (40, 140, 240, 340), having a form coupling profile for reception and locking in rotation of a brake disc (280), and with a thread (50, 150, 250, 350), adapted to receive, via screwing, a ring nut (290) which holds the brake disc (280) on said disc seat (40, 140, 240), characterised in that said thread (50, 150, 250, 350) is formed on a portion of the tubular body (11, 111, 211) which is axially separate from the disc seat (40, 140, 240) and closer than the latter to the second end (13, 113, 213) of the tubular body (11, 111, 211).

30. Hub adapted to be employed in a wheel (3, 4) of a bicycle (1) of the type having disc brake (6), comprising a tubular body (11, 111, 211) extended axially along a rotation axis (X, Y) of the wheel (3, 4) between a first (12, 112, 212) and a second (13, 113, 213) end, the tubular body (11, 111, 211) being provided in proximity to a second end (13, 113, 213) thereof with a disc seat (40, 140, 240), having a form coupling profile for reception and locking in rotation of a brake disc (280), and with a thread (50, 150, 250), adapted to receive, via screwing, a ring nut (290) which holds the brake disc (280) on said disc seat (40, 140, 240), further comprising a spindle (17, 117, 217), rotatably supported inside the tubular body (11, 111, 211) by means of a first (18, 118, 218) and a second (19, 119, 219) rolling bearing, respectively placed in proximity to the first (12, 112, 212) and second (13, 113, 213) ends of the tubular body (11, 111, 211), characterised in that the second rolling bearing (19, 119, 219) has a greater axial and a lesser radial extension with respect to the first rolling bearing (18, 118, 218).

31. Hub according to claim 30, wherein the second bearing (19, 119, 219) is a double row ball bearing.

32. Hub according to claim 31, wherein each of the two ball rows (91, 92) of the second bearing (19, 119, 219) runs along an inner runway (93, 95) and an outer runway (94, 96), made in respective inner (19a, 119a, 219a) and outer (19b, 119b, 219b) races of the second bearing (19, 119, 219), where one (94) of the inner or outer runways on which one (91) of the two ball rows runs has a greater width than the other runways (93, 95, 96) of the second bearing (19, 119, 219).

33. Hub p according to claim 32, wherein the runway (94) having greater width is one of the runways (93, 94) on which the ball row (91) runs which is oriented towards the first end (12, 112, 212) of the tubular body (11, 111, 211).

34. Hub according to claim 32, wherein the runway (94) having greater width is one of the two outer runways (94, 96).

35. Hub according to claim 32, wherein the runway having greater width is the outer runway (94) of the ball row (91) oriented towards the first end (12, 112, 212) of the tubular body (11, 111, 211).

36. Hub adapted to be engaged in a wheel (3, 4) of a bicycle (1), comprising a tubular body (11, 111, 211) axially extended along a rotation axis (X, Y) of the wheel (3, 4) between a first (12, 112, 212) and a second (13, 113, 213) end, a spindle (17, 117, 217) rotatably supported inside the tubular body (11, 111, 211) by means of a first (18, 118, 218) and a second (19, 119, 219) rolling bearing, characterised in that at least one (19, 119, 219) between the first and second rolling bearing is a double row ball bearing (91, 92), in which each of the two ball rows (91, 92) of said bearing (19, 119, 219) runs on an inner runway (93, 95) and an outer runway (94, 96), made in respective inner (19a, 119a, 219a) and outer (19b, 119b, 219b) races of said bearing (19, 119, 219), wherein one (94) of the inner or outer runways on which one (91) of the two ball rows runs has greater width than the other runways (93, 95, 96) of said bearing (19, 119, 219).

37. Hub p according to claim 36, wherein the runway (94) having greater width is one of the two outer runways (94, 96).

38. Hub according to claim 37, wherein the runway having greater width is the outer runway (94) of the ball row (91) oriented towards the first end (12, 112, 212) of the tubular body (11, 111, 211).

39. Group comprising a tubular body (11, 111, 211) extended axially along a rotation axis (X, Y), and a spindle (17, 117, 217) rotatably supported inside the tubular body (11, 111, 211) by means of at least one rolling bearing (19, 119, 219), characterised in that said at least one rolling bearing is a double row ball bearing (91, 92), in which each of the two ball rows (91, 92) runs on an inner runway (93, 95) and an outer runway (94, 96), made in respective inner (19a, 119a, 219a) and outer (19b, 119b, 219b) races of said bearing (19, 119, 219), where one (94) of the inner or outer runways on which one (91) of the two ball rows runs has greater width than the other runways (93, 95, 96) of said bearing (19, 119, 219).

40. Double row ball rolling bearing (91, 92), wherein each of the two ball rows (91, 92) runs on an inner runway (93, 95) and an outer runway (94, 96), made in respective inner (19a, 119a, 219a) and outer (19b, 119b, 219b) races of said bearing (19, 119, 219), wherein one (94) of the inner or outer runways on which one (91) of the two ball rows runs has a greater width than the other runways (93, 95, 96) of said bearing (19, 119, 219).

41. A bicycle hub having a disc brake (6), the hub comprising:
a tubular body (11, 111, 211, 311) having a rotational axis (X, Y) and first (12, 112, 212) and second (13, 113, 213) ends with a selected one of said ends defining:
a disc seat (40, 140, 240, 340 that mates with a brake disc (280), and
a threaded portion (50, 150, 250, 350) that mates with a ring nut (290) that holds the brake disc (280) on said disc seat (40, 140, 240), said threaded portion (50, 150, 250, 350) is formed on an outer portion of the tubular body (11, 111, 211) which is axially separated from the disc seat (40, 140, 240) along the rotational axis (X, Y) of the tubular body (11, 111, 211) by an unthreaded portion of the tubular body (11, 111, 211) that has the same outer diameter of the threaded portion (50, 150, 250, 350).

42. A bicycle hub having a disc brake (6), the hub comprising:
a tubular body (11, 111, 211, 311) having a rotational axis (X, Y) and first (12, 112, 212) and second (13, 113, 213) ends with a selected one of said ends defining:
a disc seat (40, 140, 240, 340 that mates with a brake disc (280), said disc seat having ribs (44, 144, 244) with a maximum diameter (D_{c})and grooves (45, 145, 245), and
a threaded portion (50, 150, 250, 350) that mates with a ring nut (290) that holds the brake disc (280) on said disc seat (40, 140, 240), said threaded portion (50, 150, 250, 350) is formed on an outer portion of the tubular body (11, 111, 211) which is axially separated from the disc seat (40, 140, 240) along the rotational axis (X, Y) of the tubular body (11, 111, 211) by an unthreaded portion of the tubular body (11, 111, 211), said threaded portion (50, 150, 250, 350) has an outer diameter (Dₑ) that is no greater than the diameter (D_{c}).

43. A bicycle hub having a disc brake (6), the hub comprising:
a tubular body (11, 111, 211, 311) having a rotational axis (X, Y) and first (12, 112, 212) and second (13, 113, 213) ends with a selected one of said ends defining:
a disc seat (40, 140, 240, 340) that has ribs (44, 144, 244) and grooves (45, 145, 245) with radial extension comprised between 0.5 and 2 mm and mates with a complementary brake disc (280), and
a threaded portion (50, 150, 250, 350) that mates with a ring nut (290) that holds the brake disc (280) on said disc seat (40, 140, 240), said threaded portion (50, 150, 250, 350) is formed on an outer portion of the tubular body (11, 111, 211) which is axially separated from the disc seat (40, 140, 240) along the rotational axis (X, Y) of the tubular body (11, 111, 211).

44. A bicycle hub having a disc brake (6), the hub comprising:
a tubular body (11, 111, 211, 311) having a rotational axis (X, Y) and first (12, 112, 212) and second (13, 113, 213) ends with a selected one of said ends defining:
a disc seat (40, 140, 240, 340) that has a total of ribs (44, 144, 244) and grooves (45, 145, 245) that number between 10 and 60, and
a threaded portion (50, 150, 250, 350) that mates with a ring nut (290) that holds the brake disc (280) on said disc seat (40, 140, 240), said threaded portion (50, 150, 250, 350) is formed on an outer portion of the tubular body (11, 111, 211) which is axially separated from the disc seat (40, 140, 240) along the rotational axis (X, Y) of the tubular body (11, 111, 211).

45. The bicycle hub according to claim 44, wherein the number of ribs and grooves is between 20 and 60.

46. The bicycle hub group according to claim 44, wherein the number of ribs and grooves is between 40 and 60.

47. A bicycle hub having a disc brake (6), the hub comprising:
a tubular body (11, 111, 211, 311) having a rotational axis (X, Y) and first (12, 112, 212) and second (13, 113, 213) ends with a selected one of said ends defining:
a disc seat (40, 140, 240, 340 that mates with a brake disc (280), and
a threaded portion (50, 150, 250, 350) that mates with a ring nut (290) that holds the brake disc (280) on said disc seat (40, 140, 240), said threaded portion (50, 150, 250, 350) is axially separated from the disc seat (40, 140, 240) along the rotational axis (X, Y) of the tubular body (11, 111, 211) and positioned between unthreaded portions of the tubular body (11, 111, 211).

48. A bicycle hub having a disc brake (6), the hub comprising:
a tubular body (11, 111, 211, 311) having a rotational axis (X, Y) and first (12, 112, 212) and second (13, 113, 213) ends with a selected one of said ends defining:
a disc seat (40, 140, 240, 340) that has ribs (44, 144, 244) and grooves (45, 145, 245) that are trapezoidal, and
a threaded portion (50, 150, 250, 350) that mates with a ring nut (290) that holds the brake disc (280) on said disc seat (40, 140, 240), said threaded portion (50, 150, 250, 350) is formed on an outer portion of the tubular body (11, 111, 211) which is axially separated from the disc seat (40, 140, 240) along the rotational axis (X, Y) of the tubular body (11, 111, 211).
